(19) United States
(12) Patent Application Publication
(10) Pub. No.: US 2025/0005429 A1
(43) Pub. Date: Jan. 2, 2025

(54) SYSTEM AND METHOD FOR DETERMINING CUMULATIVE OPTIMAL GLOBAL MINIMA ERROR FOR A SYSTEM USING COMPOSITE ARTIFICIAL INTELLIGENCE MODELING

(71) Applicant: BANK OF AMERICA CORPORATION, Charlotte, NC (US)

(72) Inventors: Jorge Kara, Kirkland, WA (US); Vijay Kumar Yarabolu, Hyderabad City (IN)

(73) Assignee: BANK OF AMERICA CORPORATION, Charlotte, NC (US)

(21) Appl. No.: 18/215,979

(22) Filed: Jun. 29, 2023

(51) Int. Cl. G06N 20/00

(52) U.S. Cl. CPC G06N 20/00

(57) ABSTRACT

Systems, computer program products, and methods are described herein for determining cumulative optimal global minima error for a system using composite artificial intelligence modeling. The present disclosure comprises a composite artificial intelligence model, wherein the composite artificial intelligence model comprises one or more component artificial intelligence models. The present disclosure is configured to receive one or more component level optimal error points, wherein the one or more component level optimal error points are associated with the one or more component artificial intelligence models. The present disclosure aggregates the one or more component level optimal error points and determines an optimal error point, wherein the optimal error point is associated with the composite artificial intelligence model. The present disclosure receives an acceptance criteria, compares the optimal error point with the acceptance criteria, and may accept, in response to the optimal error point meeting the acceptance criteria, the optimal error point.

### TECHNOLOGICAL FIELD

Example embodiments of the present disclosure relate to determining cumulative optimal global minima error for a system using composite artificial intelligence modeling.

### BACKGROUND

Determining a global minima for artificial intelligence models can pose a significant challenge during the progression of the learning process. Applicant has identified a number of deficiencies and problems associated with determining cumulative optimal global minima error for a system using composite artificial intelligence modeling. Through applied effort, ingenuity, and innovation, many of these identified problems have been solved by developing solutions that are included in embodiments of the present disclosure, many examples of which are described in detail herein BRIEF SUMMARY

Systems, methods, and computer program products are provided for determining cumulative optimal global minima error for a system using composite artificial intelligence modeling.

Embodiments of the present invention address the above needs and/or achieve other advantages by providing apparatuses (e.g., a system, computer program product, and/or other devices) and methods for determining cumulative optimal global minima error for a system using composite artificial intelligence modeling. The system embodiments may comprise a processing device and a non-transitory storage device containing instructions when executed by the processing device, to perform the steps disclosed herein. In computer program product embodiments of the invention, the computer program product comprises a non-transitory computer-readable medium comprising code causing an apparatus to perform the steps disclosed herein. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the steps disclosed herein.

In some embodiments, the present invention receives, from a composite artificial intelligence model, wherein the composite artificial intelligence model comprises one or more component artificial intelligence models, one or more component level optimal error points, wherein the one or more component level optimal error points are associated with the one or more component artificial intelligence models. In some embodiments, the present invention causes the processing device to aggregate the one or more component level optimal error points. In some embodiments, the present invention determines, in response to the aggregated one or more component level optimal error points, an optimal error point, wherein the optimal error point is associated with the composite artificial intelligence model. In some embodiments, the present invention receives an acceptance criteria. In some embodiments, the present invention compares the optimal error point with the acceptance criteria. In some embodiments, the present invention accepts, in response to the optimal error point meeting the acceptance criteria, the optimal error point.

In some embodiments, comparing the optimal error point with the acceptance criteria comprises creating a decision spectrum; defining the acceptance criteria associated with the decision spectrum; receiving one or more component metrics, wherein the one or more component metrics are associated with the one or more component artificial intelligence models; determining, in response to the one or more received component metrics, a component score; comparing the component score with the acceptance criteria; and determining whether the component score meets the acceptance criteria.

In some embodiments, the acceptance criteria comprises a predetermined acceptance score associated with the composite artificial intelligence model. In some embodiments, the present invention packages, in response to the optimal error point being accepted, the optimal error point into the composite artificial intelligence model. In some embodiments, the present invention implements the composite artificial intelligence model into a production environment.

In some embodiments, the present invention retrains, in response to the optimal error point being outside of the acceptance criteria, the composite artificial intelligence model.

In some embodiments, retraining the composite artificial intelligence model comprises reconfiguring one or more hyperparameters associated with the one or more component artificial intelligence models. In some embodiments, retraining the composite artificial intelligence model further comprises receiving additional training data associated with the one or more component artificial intelligence models.

In some embodiments, reconfiguring the one or more hyperparameters comprises receiving historical data associated with the one or more component artificial intelligence models. In some embodiments, reconfiguring the one or more hyperparameters further comprises comparing the historical data with the optimal error point. In some embodiments, reconfiguring the one or more hyperparameters further still comprises determining, in response to comparing the historical data and the optimal error point, one or more unoptimized component artificial intelligence models. In some embodiments, reconfiguring the one or more hyperparameters further still comprises reconfiguring the one or more hyperparameters associated with the one or more unoptimized component artificial intelligence models.

In some embodiments, the acceptance criteria is updated to an updated acceptance criteria in response to receiving additional training data associated with the one or more component artificial intelligence models.

In some embodiments, determining cumulative optimal global minima error for a system using composite artificial intelligence modeling further comprises: determining an amount of resources required to implement the composite artificial intelligence model; and conserving one or more resources associated with the composite artificial intelligence model.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for determining cumulative optimal global minima error for a system using composite artificial intelligence modeling, in accordance with an embodiment of the disclosure;

FIG. 2 illustrates a process flow for accepting an optimal error point, in accordance with an embodiment of the disclosure.

FIG. 3 illustrates a process flow for determining whether a component score meets an acceptance criteria, in accordance with an embodiment of the disclosure.

FIG. 4 illustrates a process flow for implementing a composite artificial intelligence model into a production environment, in accordance with an embodiment of the disclosure.

FIG. 5 illustrates a process flow for reconfiguring one or more hyperparameters associated with one or more unoptimized component artificial intelligence models, in accordance with an embodiment of the disclosure.

FIG. 6 illustrates a process flow of an example process associated with example embodiments described herein.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

Complex business solutions require composite artificial intelligence models rather than a single, monolithic artificial intelligence model. A composite artificial intelligence model may be a compilation of multiple component artificial intelligence models that may work in unison to achieve more accuracy in decisions. This is especially the case when a system has too many complex data sources and many complex decisions are involved in the system. Currently, there is no solution for deriving a global minima in composite artificial intelligence models during the learning process. In addition, determining a global minima within the context of a mutually exclusive scenario provides substantial difficulties. Further, there is no solution or rule for concluding the global minima in composite artificial intelligence models. Presently, solutions merely comprise of hyperparameter tuning until the error is at an acceptable level, with respect to the training data. The cumulative error in these processes, however, may not meet the acceptable criteria from an institutional or corporate standpoint, especially in the case of mutually exclusive scenarios (e.g., when a system needs to decide between security and customer experience).

Embodiments of the present disclosure provide for determining cumulative optimal global minima error for a system using composite artificial intelligence modeling. In this regard, and by way of non-limiting example, the system may receive component level error points from component artificial intelligence models. The system may aggregate (e.g., combine) the component level error points to determine an optimal error point. The optimal error point relates to the composite artificial intelligence model (e.g., the main model made up of the component models). The system may receive an acceptance criteria (e.g., criteria, which may be defined by an entity housing the composite model, that relates to an error point target the entity is looking to meet). The system may then compare the optimal error point and the acceptance criteria. If the optimal error point meets the acceptance criteria, the system may accept the optimal error point and implement the optimal error point in the composite artificial intelligence model to be used in a production-level environment.

What is more, the present disclosure provides a technical solution to a technical problem. As described herein, the technical problem includes deriving a global minima in the artificial intelligence model learning process. The technical solution presented herein allows for accurate and effective determination of the global minima for a system. In particular, determining cumulative optimal global minima error for a system using composite artificial intelligence modeling is an improvement over existing solutions to the problem of determining a global minima for the system, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

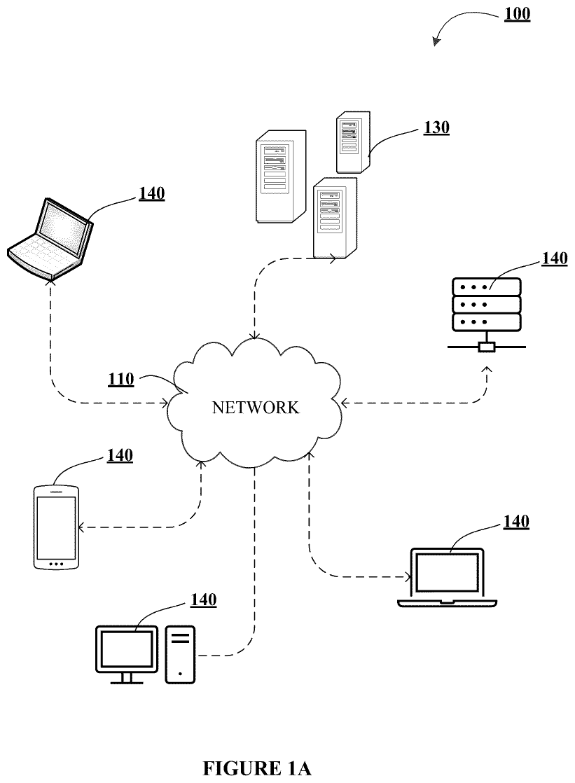

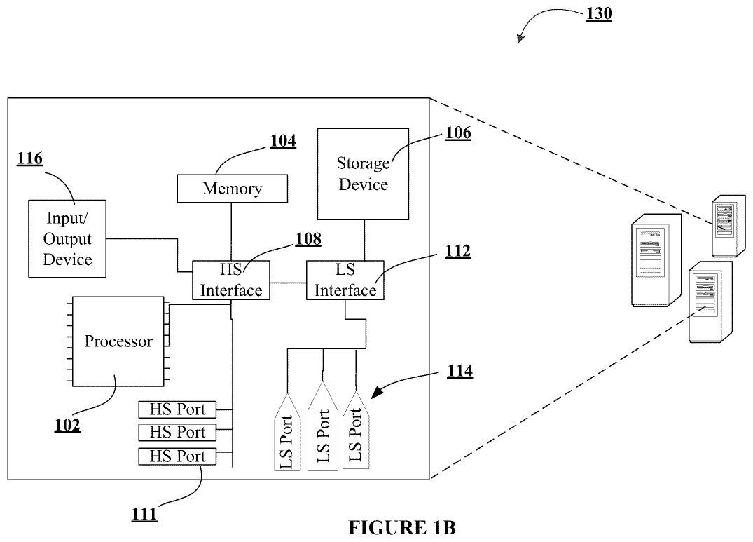

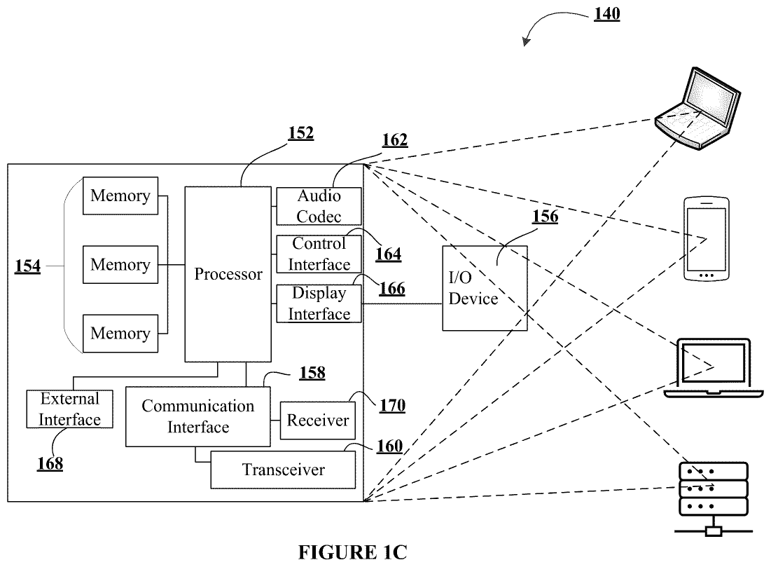

FIGS. 1A-1C illustrate technical components of an exemplary distributed computing environment for determining cumulative optimal global minima error for a system using composite artificial intelligence modeling 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. In some embodiments, the network 110 may include a telecommunication network, local area network (LAN), a wide area network (WAN), and/or a global area network (GAN), such as the Internet. Additionally, or alternatively, the network 110 may be secure and/or unsecure and may also include wireless and/or wired and/or optical interconnection technology. The network 110 may include one or more wired and/or wireless networks. For example, the network 110 may include a cellular network (e.g., a long-term evolution (LTE) network, a code division multiple access (CDMA) network, a 3G network, a 4G network, a 5G network, another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, storage device 106, a high-speed interface 108 connecting to memory 104, high-speed expansion points 111, and a low-speed interface 112 connecting to a low-speed bus 114, and an input/output (I/O) device 116. The system 130 may also include a high-speed interface 108 connecting to the memory 104, and a low-speed interface 112 connecting to low-speed port 114 and storage device 106. Each of the components 102, 104, 106, 108, 111, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system. The processor 102 may process instructions for execution within the system 130, including instructions stored in the memory 104 and/or on the storage device 106 to display graphical information for a GUI on an external input/output device, such as a display 116 coupled to a high-speed interface 108. In some embodiments, multiple processors, multiple buses, multiple memories, multiple types of memory, and/or the like may be used. Also, multiple systems, same or similar to system 130, may be connected, with each system providing portions of the necessary operations (e.g., as a server bank, a group of blade servers, a multi-processor system, and/or the like). In some embodiments, the system 130 may be managed by an entity, such as a business, a merchant, a financial institution, a card management institution, a software and/or hardware development company, a software and/or hardware testing company, and/or the like. The system 130 may be located at a facility associated with the entity and/or remotely from the facility associated with the entity.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 may store information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

In some embodiments, the system 130 may be configured to access, via the network 110, a number of other computing devices (not shown). In this regard, the system 130 may be configured to access one or more storage devices and/or one or more memory devices associated with each of the other computing devices. In this way, the system 130 may implement dynamic allocation and de-allocation of local memory resources among multiple computing devices in a parallel and/or distributed system. Given a group of computing devices and a collection of interconnected local memory devices, the fragmentation of memory resources is rendered irrelevant by configuring the system 130 to dynamically allocate memory based on availability of memory either locally, or in any of the other computing devices accessible via the network. In effect, the memory may appear to be allocated from a central pool of memory, even though the memory space may be distributed throughout the system. Such a method of dynamically allocating memory provides increased flexibility when the data size changes during the lifetime of an application and allows memory reuse for better utilization of the memory resources when the data sizes are large.

The high-speed interface 108 manages bandwidth-intensive operations for the system 130, while the low-speed interface 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed interface 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router (e.g., through a network adapter).

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 156, 158, 160, 162, 164, 166, 168 and 170, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor 152 may be implemented as a chipset of chips that include separate and multiple analog and digital processors. The processor 152 may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156 (e.g., input/output device 156). The display 156 may be, for example, a Thin-Film-Transistor Liquid Crystal Display (TFT LCD) or an Organic Light Emitting Diode (OLED) display, or other appropriate display technology. An interface of the display may include appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a Single In Line Memory Module (SIMM) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner. In some embodiments, the user may use applications to execute processes described with respect to the process flows described herein. For example, one or more applications may execute the process flows described herein. In some embodiments, one or more applications stored in the system 130 and/or the user input system 140 may interact with one another and may be configured to implement any one or more portions of the various user interfaces and/or process flow described herein.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as GSM voice calls, SMS, EMS, or MMS messaging, CDMA, TDMA, PDC, WCDMA, CDMA2000, GPRS, and/or the like. Such communication may occur, for example, through transceiver 160. Additionally, or alternatively, short-range communication may occur, such as using a Bluetooth, Wi-Fi, near-field communication (NFC), and/or other such transceiver (not shown). Additionally, or alternatively, a Global Positioning System (GPS) receiver module 170 may provide additional navigation-related and/or location-related wireless data to user input system 140, which may be used as appropriate by applications running thereon, and in some embodiments, one or more applications operating on the system 130.

Further, communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications.

In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

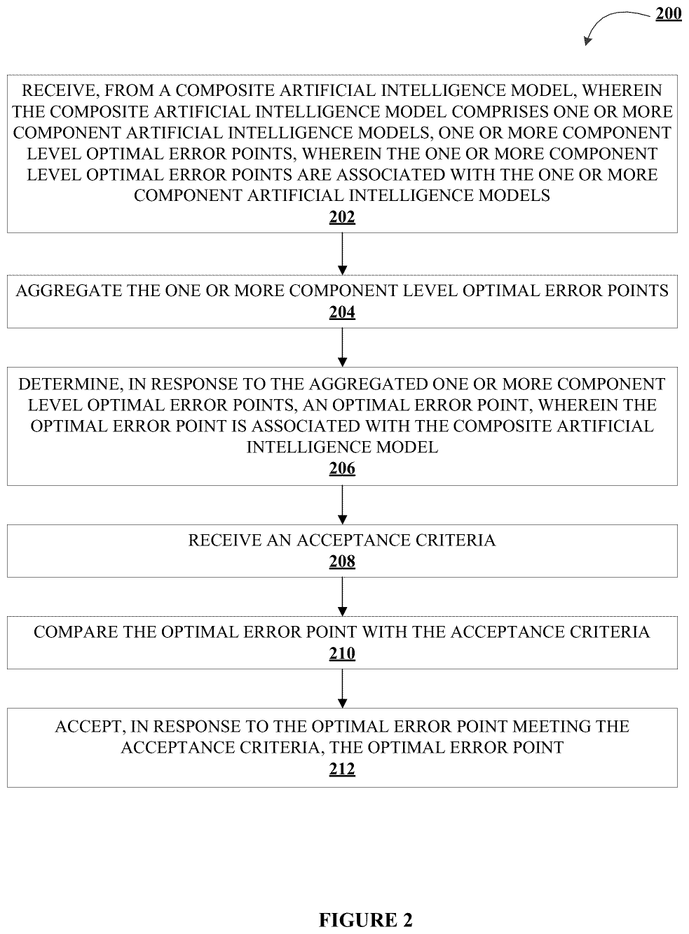

FIG. 2 is a process flow 200 which illustrates a process flow for accepting an optimal error point, in accordance with an embodiment of the disclosure. The method may be carried out by various components of the distributed computing environment 100 discussed herein (e.g., the system 130, one or more end-point device(s) 140, etc.). An example system may include at least one processing device and at least one non-transitory storage device containing instructions that, when executed by the processing device, causes the processing device to perform the method discussed herein.

In some embodiments, an optimal global minima error system (e.g., similar to one or more of the systems described herein with respect to FIGS. 1A-1C) may perform one or more of the steps of process flow 200. For example, an optimal global minima error system (e.g., the system 130 described herein with respect to FIGS. 1A-1C) may perform the steps of process flow 200.

As shown in block 202, the process flow 200 of this embodiment includes receiving, from a composite artificial intelligence model, wherein the composite artificial intelligence model comprises one or more component artificial intelligence models, one or more component level optimal error points, wherein the one or more component level optimal error points are associated with the one or more component artificial intelligence models. As used herein, a composite artificial intelligence model includes one or more component artificial intelligence models. In some embodiments, an artificial intelligence model may comprise an advanced computational model for data analysis and automated decision making. In some embodiments, the component artificial intelligence models may include various types of artificial intelligence models, including Device Analytics, Interaction Modeling, Location Analytics, Bio-Metric Trust, Network Trust, Transaction Behavior, Bot-Network Detection Score, DDoS Pattern Score, Behavior Analytics Score, and/or the like. In some embodiments, each of the component artificial intelligence models may work independently, together, or both during a particular interaction and output data associated with the interaction for analysis by the optimal global minima error system.

As used herein “component level optimal error points” may include data gathered from the one or more component artificial intelligence model(s). For instance, and by way of non-limiting example, the component level optimal error points may include metrics (e.g., data) relating to the component artificial intelligence model error values. In this way, the error values may include absolute error values outputted from an artificial intelligence model. In some embodiments, the component level optimal error points may include a variety of error metrics, including mean absolute error, mean squared error, root mean squared error, logarithmic loss, cross-entropy, confusion matrix, precision, recall, F1 score, and/or the like. In some embodiments, there may be more than one type of error throughout a single component artificial intelligence model, between one or more different component artificial intelligence models, and/or throughout the entire composite artificial intelligence model.

As shown in block 204, the process flow 200 of this embodiment includes aggregating the one or more component level optimal error points. As used herein, “aggregating” may include, by way of non-limiting example, an arithmetic mean, a weighted average, a median, a majority rule, a rank aggregation, stacking, and/or the like. In this way, the optimal global minima error system may determine the most appropriate aggregation technique for any given component level optimal error points received. In some embodiments, one or more aggregation techniques may be used.

As shown in block 206, the process flow 200 of this embodiment includes determining, in response to the aggregated one or more component level optimal error points, an optimal error point, wherein the optimal error point is associated with the composite artificial intelligence model. As used herein, the optimal error point may include the aggregated one or more component level optimal error points. In some embodiments, the optimal error point may represent a local minimum error value associated with the composite artificial intelligence model. In some embodiments, the optimal error point and the acceptance criteria may be different values.

As shown in block 208, the process flow 200 of this embodiment includes receiving an acceptance criteria. As used herein, the acceptance criteria may include an acceptable level of error within the optimal global minima error system. For instance, and by way of non-limiting example, the acceptance criteria may include an acceptable error threshold (e.g., a maximum acceptable error rate tolerated within the system), a particular type of error that is acceptable (e.g., different acceptance rates for different types of errors, such as false positives or false negatives), whether the error rate is consistent (e.g., different acceptance rates for errors depending on the error rate consistency), whether the error can be generalized (e.g., whether new or unseen training data may produce acceptable error rates).

In some embodiments, the acceptance criteria may be received from a user of the optimal global minima error system (e.g., a manager, a technician, a user, and/or the like). In some embodiments, the acceptance criteria may be associated with an institutional decision, metric, guidance, and/or the like. In this way, the acceptance criteria may be associated with user involvement in the optimal global minima error system. In some embodiments, the acceptance criteria may be received from the optimal global minima error system itself. For instance, and by way of non-limiting example, the optimal global minima error system may determine the acceptance criteria in response to historical data of the system (e.g., historical data outputted by the composite artificial intelligence model, historical data outputted by the one or more component artificial intelligence models, any other systems the optimal global minima error system communicates with, and/or the like). Further, the optimal global minima error system may, in response to determining the acceptance criteria, suggest a viable acceptance criteria and configure a graphical user interface for a user of the system.

In some embodiments, the acceptance criteria may include a predetermined acceptance score associated with the composite artificial intelligence model. In this way, the predetermined acceptance score may be determined (e.g., predetermined) by a user of the system. In some embodiments, the predetermined acceptance score may include an acceptable error rate received from the composite artificial intelligence model. In some embodiments, the predetermined acceptance score may include one or more acceptable error rates received from the one or more component artificial intelligence models. In this way, the predetermined acceptance score may define the acceptable error rate for each of the component artificial intelligence models. Further, the predetermined acceptance score for each of the component artificial intelligence models may be the same or different.

In some embodiments, the predetermined acceptance score may include a range of predetermined acceptance scores. In this way, the range of predetermined acceptance scores would define one or more values that would create the acceptance criteria for the composite artificial intelligence model, the one or more component artificial intelligence models, and/or the like.

In some embodiments, the acceptance criteria may be updated to an updated acceptance criteria in response to receiving additional training data associated with the one or more component artificial intelligence models. In this way, the optimal global minima error system may determine, in response to receiving additional training data, as discussed below, to update the acceptance criteria to an updated acceptance criteria. In some embodiments, the optimal global minima error system may update the acceptance criteria due to a number of factors, both internal to the system and/or from external factors. For instance, and by way of non-limiting example, the optimal global minima error system may update the acceptance criteria because of a change in model complexity (e.g., the composite or component artificial intelligence models may become more or less complex, which may require an updated acceptance criteria), availability of more training data, model updates or refinements (e.g., the composite or component artificial intelligence models may be refined, which may cause a shift in the acceptable error rate), changes in evaluation metrics (e.g., the way the optimal global minima error system's performance is measured may change, which may require an updated acceptance criteria), and/or the like. Similarly, and by way of non-limiting examples, external factors may cause the acceptance criteria to be updated, such as a shift in the problem space or requirements of the system (e.g., the nature of the problem for the optimal global minima error system may change), regulatory changes (e.g., changes in regulation from a governmental or official entity), feedback from the users of the system (e.g., a customer, manager, technician, and/or the like of the system may determine the acceptance criteria should be updated), technological advancements (e.g., standards in the technological space may require an updated acceptance criteria), and/or the like.

As shown in block 210, the process flow 200 of this embodiment includes comparing the optimal error point with the acceptance criteria. As used herein, “comparing” may include determining whether the optimal error point meets or exceeds the acceptance criteria, whether the optimal error point is within the acceptance criteria, whether the optimal error point matches the acceptance criteria, and/or the like.

As shown in block 212, the process flow 200 of this embodiment includes accepting, in response to the optimal error point meeting the acceptance criteria, the optimal error point. As used herein, “accepting” may include determining that the optimal error point meets or exceeds the acceptance criteria, the optimal error point is within the acceptance criteria, the optimal error point matches the acceptance criteria, and/or the like.

In some embodiments, determining cumulative optimal global minima error for a system using composite artificial intelligence modeling further comprises determining an amount of resources required to implement the composite artificial intelligence model. As used herein, “an amount” of resources may be any amount of resources consumed by the optimal global minima error system. In this way, the system may determine an amount of resources consumed by the system at any stage in the process.

In some embodiments, determining cumulative optimal global minima error for a system using composite artificial intelligence modeling further comprises conserving one or more resources associated with the composite artificial intelligence model. In some embodiments, the optimal global minima error system may conserve one or more resources as compared to a system that has not implemented the optimal global minima error system. In this way, the optimal global minima error system may conserve at least one or more resources as compared against the system without the optimal global minima error system.

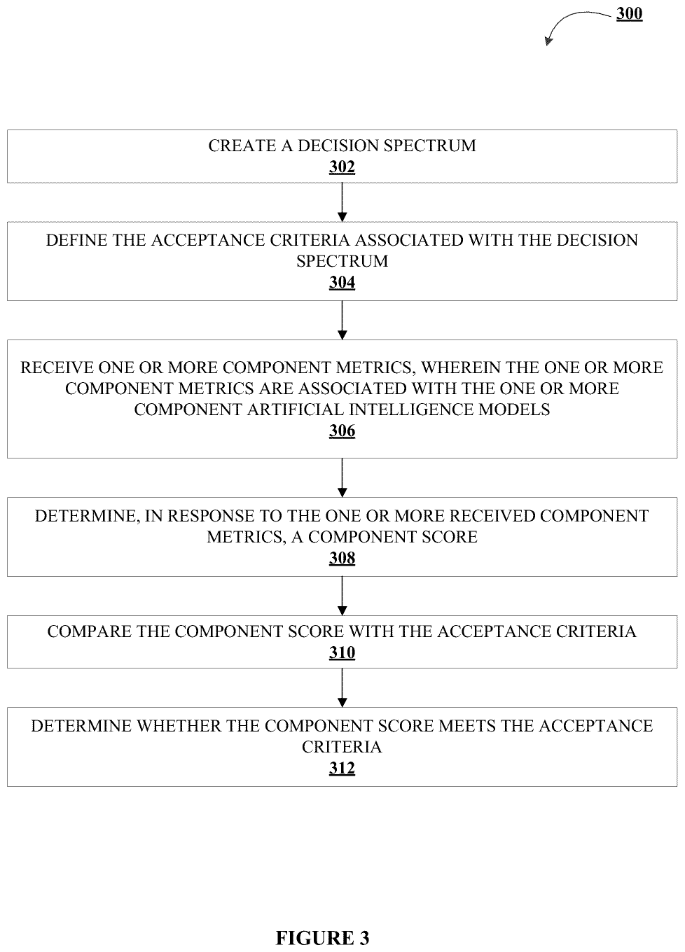

FIG. 3 is a process flow 300 which illustrates a process flow for determining whether a component score meets an acceptance criteria, in accordance with an embodiment of the disclosure. The method may be carried out by various components of the distributed computing environment 100 discussed herein (e.g., the system 130, one or more end-point device(s) 140, etc.). An example system may include at least one processing device and at least one non-transitory storage device containing instructions that, when executed by the processing device, causes the processing device to perform the method discussed herein.

In some embodiments, an optimal global minima error system (e.g., similar to one or more of the systems described herein with respect to FIGS. 1A-IC) may perform one or more of the steps of process flow 300. For example, an optimal global minima error system (e.g., the system 130 described herein with respect to FIGS. 1A-1C) may perform the steps of process flow 300.

As shown in block 302, the process flow 300 of this embodiment includes creating a decision spectrum. As used herein, the decision spectrum may relate to a range of potential outcomes of the component artificial intelligence models in response to the component artificial intelligence models' error rates (e.g., optimal error points). In some embodiments, the decision spectrum may be created based on uncertainty levels. In some embodiments, the decision spectrum may be created based on uncertainty levels in response to the one or more component level optimal error points. In some embodiments, one end of the decision spectrum may represent low uncertainty (e.g., low error rates) and the other end of the spectrum may represent high uncertainty (e.g., high error rates).

As shown in block 304, the process flow 300 of this embodiment includes defining the acceptance criteria associated with the decision spectrum. As used herein, defining the acceptance criteria associated with the decision spectrum may include using the acceptance criteria to compare the data associated with the decision spectrum with the acceptance criteria. In other words, the optimal global minima error system may include the acceptance criteria in the decision spectrum to determine whether the received data meets the acceptance criteria.

As shown in block 306, the process flow 300 of this embodiment includes receiving one or more component metrics, wherein the one or more component metrics are associated with the one or more component artificial intelligence models. As used herein, the component metrics may be associated with the component artificial intelligence models and may include a variety of different types of data. For instance, and by way of non-limiting example, the component metrics may include a variety of different types of error rates from each of the component artificial intelligence models, mentioned above (e.g., mean absolute error, mean squared error, root mean squared error, logarithmic loss, cross-entropy, confusion matrix, precision, recall, F1 score, and/or the like).

As shown in block 308, the process flow 300 of this embodiment includes determining, in response to the one or more received component metrics, a component score. As used herein, the component score may include an aggregation of the component metrics into the component score. In some embodiments, the component score may include all of the one or more component artificial intelligence models' component metrics. In some embodiments, the component score may include less than all of the one or more component artificial intelligence models' component metrics. In some embodiments, the optimal global minima error system may determine which component metrics should be included in determining the component score. In some embodiments, each of the component metrics may have a weight that is used in determining the component score. For instance, and by way of non-limiting example, a particular component metric may have a higher weight compared with other component metrics, which would relate to the particular component metric influencing the component score more than the other component metrics. In some embodiments, the weights relating to each of the component metrics may be determined by the optimal global minima error system, by a user (e.g., a manager, a technician, and/or the like), by a third party, by law or regulation, and/or the like.

As shown in block 310, the process flow 300 of this embodiment includes comparing the component score with the acceptance criteria. As used herein, “comparing” may include determining whether the component score meets or exceeds the acceptance criteria, whether the component score is within the acceptance criteria, whether the component score matches the acceptance criteria, and/or the like.

As shown in block 312, the process flow 300 of this embodiment includes determining whether the component score meets the acceptance criteria. In some embodiments, determining the component score meets the acceptance criteria may include analyzing the error-based values used, mentioned above (e.g., mean absolute error, mean squared error, root mean squared error, logarithmic loss, cross-entropy, confusion matrix, precision, recall, F1 score, and/or the like). In this way, the optimal global minima error system may determine the component score meets the acceptance criteria based on more than one error value. For instance, and by way of non-limiting example, if the component score comprises one or more error values, the optimal global minima error system may analyze all of the error values to determine whether the component score meets the acceptance criteria.

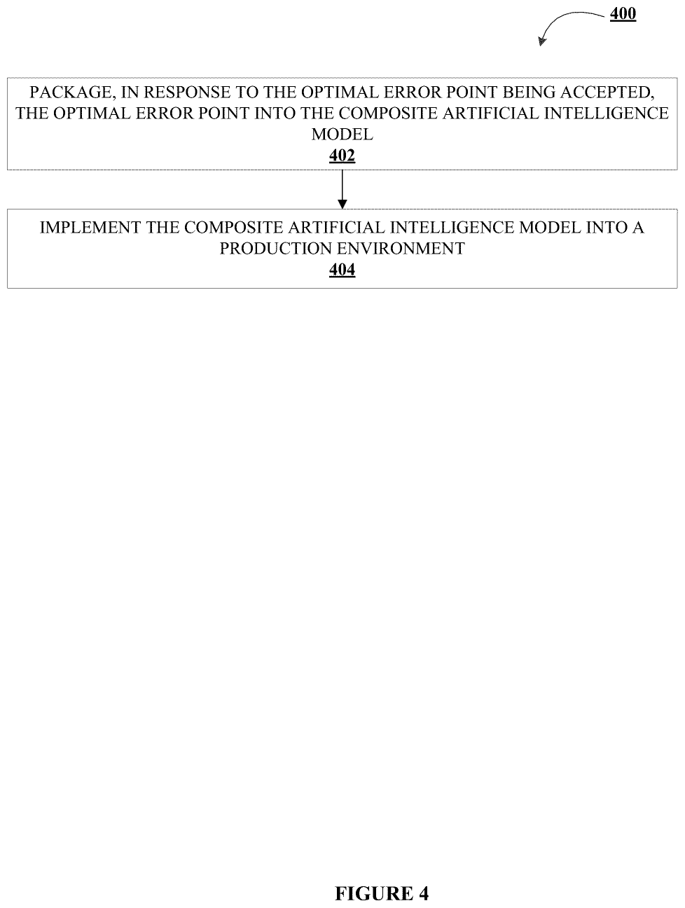

FIG. 4 is a process flow 400 which illustrates a process flow for implementing a composite artificial intelligence model into a production environment, in accordance with an embodiment of the disclosure. The method may be carried out by various components of the distributed computing environment 100 discussed herein (e.g., the system 130, one or more end-point device(s) 140, etc.). An example system may include at least one processing device and at least one non-transitory storage device containing instructions that, when executed by the processing device, causes the processing device to perform the method discussed herein.

In some embodiments, an optimal global minima error system (e.g., similar to one or more of the systems described herein with respect to FIGS. 1A-IC) may perform one or more of the steps of process flow 400. For example, an optimal global minima error system (e.g., the system 130 described herein with respect to FIGS. 1A-1C) may perform the steps of process flow 400.

As shown in block 402, the process flow 400 of this embodiment includes packaging, in response to the optimal error point being accepted, the optimal error point into the composite artificial intelligence model. As used herein, “packaging” may include preparing the composite artificial intelligence model for deployment or distribution. In some embodiments, packaging the optimal error point into the composite artificial intelligence model may include saving model parameters (e.g., settings, or the like), saving dependency information (e.g., details the composite artificial intelligence model depends on for processing), preprocessing and postprocessing (e.g., any preprocessing or postprocessing requirements the composite artificial intelligence model relies upon), containerization (e.g., isolated environments that run the composite artificial intelligence model regardless of the environment of the host), and/or the like.

As shown in block 404, the process flow 400 of this embodiment includes implementing the composite artificial intelligence model into a production environment. As used herein, “implementing” may include any processes required for the deployment of the composite artificial intelligence model in a production environment. In some embodiments, implementing (e.g., deploying) may include integrating (e.g., integrated with existing production systems), scaling (e.g., ensuring the composite artificial intelligence model is capable of handling an increased load), monitoring (e.g., monitoring the composite artificial intelligence model's performance after implementation), updating (e.g., retraining or upgrading the composite artificial intelligence model from time to time), versioning (e.g., detailing reasons for updated model(s) and model parameter(s)), and/or the like.

As used herein, the production environment may include an environment where the composite artificial intelligence model may interact with data that is made up of at least partially made up of live, real-world data.

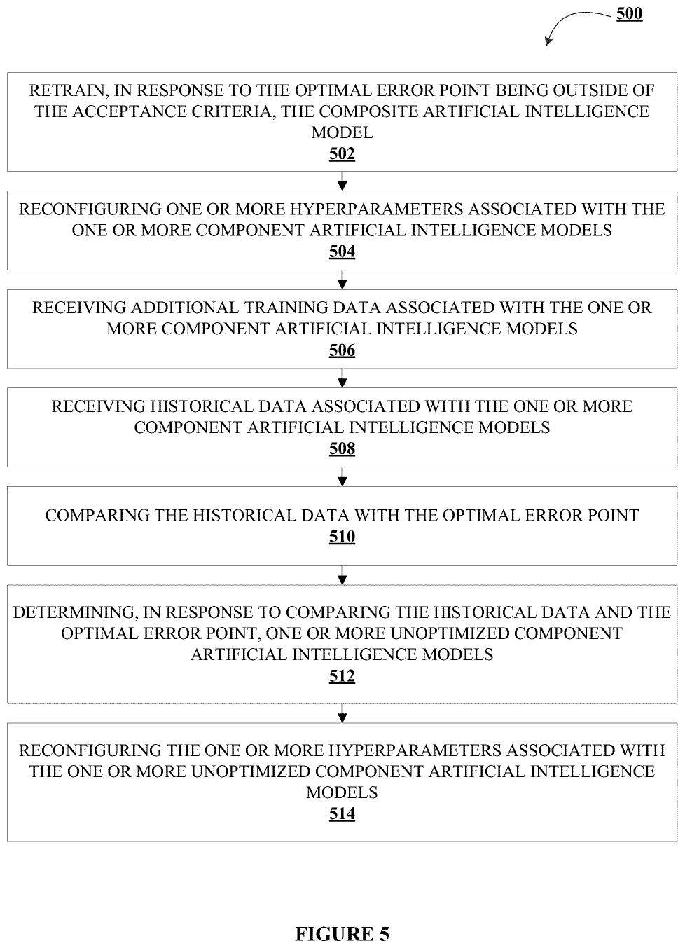

FIG. 5 is a process flow 500 which illustrates a process flow for reconfiguring one or more hyperparameters associated with one or more unoptimized component artificial intelligence models, in accordance with an embodiment of the disclosure. The method may be carried out by various components of the distributed computing environment 100 discussed herein (e.g., the system 130, one or more end-point device(s) 140, etc.). An example system may include at least one processing device and at least one non-transitory storage device containing instructions that, when executed by the processing device, causes the processing device to perform the method discussed herein.

In some embodiments, an optimal global minima error system (e.g., similar to one or more of the systems described herein with respect to FIGS. 1A-IC) may perform one or more of the steps of process flow 500. For example, an optimal global minima error system (e.g., the system 130 described herein with respect to FIGS. 1A-1C) may perform the steps of process flow 500.

As shown in block 502, the process flow 500 of this embodiment includes retraining, in response to the optimal error point being outside of the acceptance criteria, the composite artificial intelligence model. As used herein, “retraining” may include updating, improving, refining, and/or the like, the composite artificial intelligence model. In some embodiments, retraining may include using new training data, old training data, or a combination of old and new training data. In some embodiments, retraining the composite artificial intelligence model may occur in response to the optimal error point being outside of the acceptance criteria (e.g., a mismatch, nonconformance, and/or the like of the optimal error point and the acceptance criteria).

In some embodiments, retraining may include preprocessing the received additional training data. In some embodiments, retraining may include evaluating the retrained composite artificial intelligence model to determine whether the retraining procedure was adequate.

As shown in block 504, the process flow 500 of this embodiment includes reconfiguring one or more hyperparameters associated with the one or more component artificial intelligence models. As used herein, “reconfiguring” may include updating model parameters, changing the model architecture, incorporating more or different features, adjusting the training process for the model, using different quality data, and/or the like. In some embodiments, reconfiguring the hyperparameters may include adjusting the settings that control the learning process of the component artificial intelligence model, such as the learning rate, the number of layers in the neural network, artificial neurons in the hidden layer, the regularization strength, and/or the like. In some embodiments, the optimal global minima error system may reconfigure the hyperparameters though a variety of methods, such as a grid search (e.g., searching through a specified subset of the hyperparameter space of the component artificial intelligence model), a random search (e.g., randomly selecting hyperparameters of the component artificial intelligence model to reconfigure), a Bayesian optimization (e.g., selecting hyperparameters based on probability of increasing model performance), gradient-based optimization (e.g., selecting and reconfiguring hyperparameters based on gradient descent), and/or the like.

As shown in block 506, the process flow 500 of this embodiment includes receiving additional training data associated with the one or more component artificial intelligence models. In some embodiments, retraining may include receiving additional training data, wherein the additional training data may include data from data repositories (e.g., containing old and/or new training data), user feedback (e.g., feedback from a user, a customer, a manager, a technician, and/or the like), regulatory requirements (e.g., data from law or regulation requirements received from official or governmental entities), and/or the like.

As shown in block 508, the process flow 500 of this embodiment includes receiving historical data associated with the one or more component artificial intelligence models. In some embodiments, the historical data received may relate to historical component metrics (e.g., historical data) associated with the one or more component artificial intelligence models. Further, the optimal global minima error system may use historical component metrics, such as historical performance, historical accuracy, historical precision, historical error values, and/or the like.

As shown in block 510, the process flow 500 of this embodiment includes comparing the historical data with the optimal error point. In some embodiments, comparing the historical data with the optimal error point may include analyzing a particular historical component metric with the optimal error point. In this way, the system may determine whether a component artificial intelligence model tends to perform in a particular way under certain circumstances. For instance, and by way of non-limiting example, if the historical data of a particular component artificial intelligence model shows consistent underperformance, the system may determine the model is unoptimized and requires reconfiguration.

As shown in block 512, the process flow 500 of this embodiment includes determining, in response to comparing the historical data and the optimal error point, one or more unoptimized component artificial intelligence models. In some embodiments, determining a component artificial intelligence model is unoptimized may result from an analysis of a variety of factors. For instance, and by way of non-limiting example, the component artificial intelligence model may be determined to be unoptimized due to consistently high error rates (e.g., error rates that consistently fall outside of the acceptance criteria), low accuracy (e.g., low accuracy of the component artificial intelligence model's classification), poor precision or recall (e.g., many false positives or false negatives), high bias (e.g., an oversimplification of the data), deterioration of results (e.g., drift in data which may happen over a given time period), inconsistent results (e.g., inconsistent results from the same or similar input data), and/or the like.

As shown in block 514, the process flow 500 of this embodiment includes reconfiguring the one or more hyperparameters associated with the one or more unoptimized component artificial intelligence models. In some embodiments, the unoptimized component artificial intelligence model may be reconfigured to mitigate (e.g., correct) the underlying issues that caused the un-optimization.

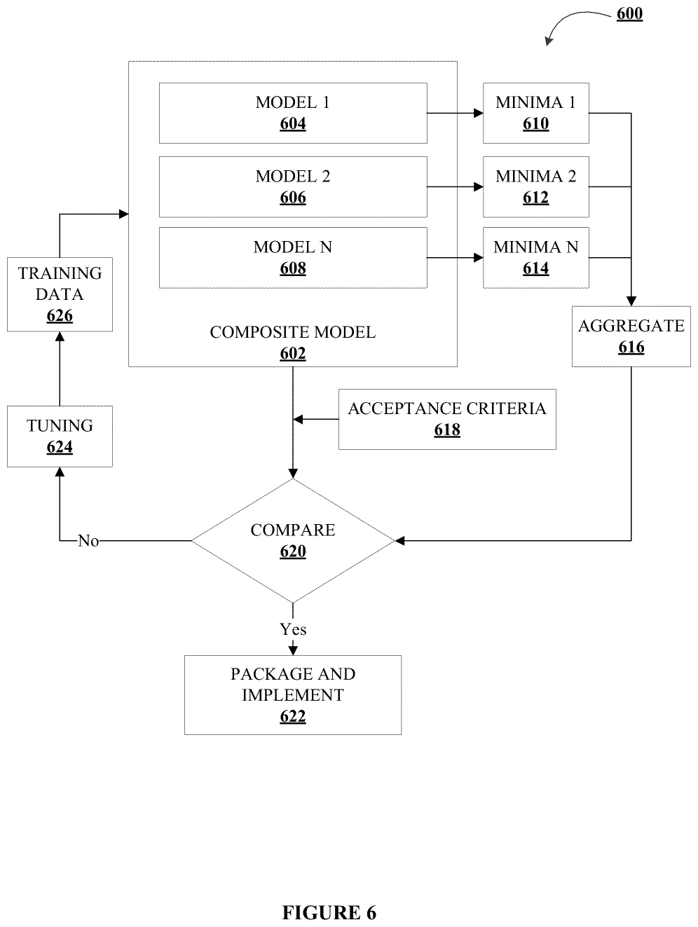

FIG. 6 is a process flow 600 which illustrates a process flow of an example process associated with example embodiments described herein. The method may be carried out by various components of the distributed computing environment 100 discussed herein (e.g., the system 130, one or more end-point device(s) 140, etc.). An example system may include at least one processing device and at least one non-transitory storage device containing instructions that, when executed by the processing device, causes the processing device to perform the method discussed herein.

In some embodiments, an optimal global minima error system (e.g., similar to one or more of the systems described herein with respect to FIGS. 1A-IC) may perform one or more of the steps of process flow 600. For example, an optimal global minima error system (e.g., the system 130 described herein with respect to FIGS. 1A-1C) may perform the steps of process flow 600.

As shown in block 602 of process flow 600, the composite artificial intelligence model may comprise one or more component artificial intelligence models, represented by blocks 604, 606, and 608. In some embodiments, the number of component artificial intelligence models may be any number of component artificial intelligence models. For instance, and by way of non-limiting example, an application for the optimal global minima error system may include determining a global minima for a system dealing with a mutually exclusive scenario. In this way, the mutually exclusive scenario may, for example, relate to the two competing scenarios of stronger authentication (e.g., system security) and customer experience.

As shown in block 604 of process flow 600, a component artificial intelligence model may be included in the composite artificial intelligence model (e.g., block 602). In some embodiments, the component artificial intelligence model may include a variety of different applications, such as Device Analytics, Interaction Modeling, Location Analytics, Bio-Metric Trust, Network Trust, Transaction Behavior, Bot-Network Detection Score, DDoS Pattern Score, Behavior Analytics Score, and/or the like.

As shown in block 606 of process flow 600, another component artificial intelligence model may be included in the composite artificial intelligence model (e.g., block 602). In some embodiments, the component artificial intelligence model may include a variety of different applications, such as Device Analytics, Interaction Modeling, Location Analytics, Bio-Metric Trust, Network Trust, Transaction Behavior, Bot-Network Detection Score, DDoS Pattern Score, Behavior Analytics Score, and/or the like.

As shown in block 608, any number of component artificial intelligence models may be included in the composite artificial intelligence model (e.g., block 602). In some embodiments, any of the component artificial intelligence models may include a variety of different applications, such as Device Analytics, Interaction Modeling, Location Analytics, Bio-Metric Trust, Network Trust, Transaction Behavior, Bot-Network Detection Score, DDoS Pattern Score, Behavior Analytics Score, and/or the like.

As shown in blocks 610, 612, and 614 of process flow 600, the optimal global minima error system may receive one or more component level optimal error points, wherein the one or more component level optimal error points are associated with the one or more component artificial intelligence models (e.g., blocks 604, 606, and 606). In this way, the component level optimal error points (e.g., minima error associated with the component artificial intelligence model) corresponds to the respective component artificial intelligence model.

As shown in block 616 of process flow 600, the optimal global minima error system may aggregate the one or more component level optimal error points. In some embodiments, the optimal global minima error system may aggregate the component level optimal error points in a variety of ways. In some embodiments, the optimal global minima error system may determine, in response to the aggregated one or more component level optimal error points, an optimal error point, wherein the optimal error point is associated with the composite artificial intelligence model. In this way, the optimal error point may relate to the composite artificial intelligence model's lowest error value (e.g., lowest absolute error value).

As shown in block 618 of process flow 600, the optimal global minima error system may receive an acceptance criteria. In some embodiments, the acceptance criteria may be received from a user of the optimal global minima error system (e.g., a technician, an entity, a third party, and/or the like). For instance, and by way of non-limiting example, if the optimal global minima error system were to receive an acceptance criteria from an entity, the entity may have certain reasoning behind the acceptance criteria. For example, the entity may have business-minded decisioning, a target goal for the optimal global minima error system upon implementation, testing new artificial intelligence model training techniques, improved data analytics techniques or processes, and/or the like. In another instance, and by way of non-limiting example, if an entity is dealing with a mutually exclusive scenario (e.g., stronger authentication versus customer experience), the entity may define the acceptance criteria in a manner that is suitable to the entity's requirements for the optimal global minima error system. In this way, the entity may have control over the acceptance criteria in order to provide the best possible customer experience while providing the strongest authentication under the circumstances.

As shown in block 620 of process flow 600, the optimal global minima error system may compare the optimal error point with the acceptance criteria. In some embodiments, the comparison process may include a variety of techniques.

As shown in block 622 of process flow 600, the optimal global minima error system may accept, in response to the optimal error point meeting the acceptance criteria, the optimal error point. In some embodiments, the optimal global minima error system may package, in response to the optimal error point being accepted, the optimal error point into the composite artificial intelligence model. In some embodiments, the optimal global minima error system may implement the composite artificial intelligence model into a production environment.

As shown in block 624 of process flow 600, the optimal global minima error system may retrain, in response to the optimal error point being outside of the acceptance criteria, the composite artificial intelligence model. In some embodiments, retraining may comprise reconfiguring one or more hyperparameters associated with the component artificial intelligence models (e.g., tuning, re-tuning, and/or the like).

As shown in block 626, the optimal global minima error system may receive additional training data associated with the one or more component artificial intelligence models. In this way, the optimal global minima error system may receive additional training data, which may comprise new (e.g., previously unused) training data, old training data, or a combination of new and old training data.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for determining cumulative optimal global minima error for a system using composite artificial intelligence modeling, the system comprising:
a processing device;
a non-transitory storage device containing instructions when executed by the processing device, causes the processing device to perform the steps of:
receive, from a composite artificial intelligence model, wherein the composite artificial intelligence model comprises one or more component artificial intelligence models, one or more component level optimal error points, and wherein the one or more component level optimal error points are associated with the one or more component artificial intelligence models;
aggregate the one or more component level optimal error points;
determine, in response to the aggregated one or more component level optimal error points, an optimal error point, wherein the optimal error point is associated with the composite artificial intelligence model;
receive an acceptance criteria;
compare the optimal error point with the acceptance criteria; and
accept, in response to the optimal error point meeting the acceptance criteria, the optimal error point.

2. The system of claim 1, wherein comparing the optimal error point with the acceptance criteria comprises:
create a decision spectrum;
define the acceptance criteria associated with the decision spectrum;
receive one or more component metrics, wherein the one or more component metrics are associated with the one or more component artificial intelligence models;
determine, in response to the one or more received component metrics, a component score;
compare the component score with the acceptance criteria; and
determine whether the component score meets the acceptance criteria.

3. The system of claim 1, wherein the acceptance criteria comprises a predetermined acceptance score associated with the composite artificial intelligence model.

4. The system of claim 1, wherein executing the instructions further causes the processing device to:
package, in response to the optimal error point being accepted, the optimal error point into the composite artificial intelligence model; and
implement the composite artificial intelligence model into a production environment.

5. The system of claim 1, wherein executing the instructions further causes the processing device to retrain, in response to the optimal error point being outside of the acceptance criteria, the composite artificial intelligence model.

6. The system of claim 5, wherein retraining the composite artificial intelligence model comprises:
reconfiguring one or more hyperparameters associated with the one or more component artificial intelligence models; and
receiving additional training data associated with the one or more component artificial intelligence models.

7. The system of claim 6, wherein reconfiguring the one or more hyperparameters comprises:
receiving historical data associated with the one or more component artificial intelligence models;
comparing the historical data with the optimal error point;
determining, in response to comparing the historical data and the optimal error point, one or more unoptimized component artificial intelligence models; and
reconfiguring the one or more hyperparameters associated with the one or more unoptimized component artificial intelligence models.

8. The system of claim 1, wherein the acceptance criteria is updated to an updated acceptance criteria in response to receiving additional training data associated with the one or more component artificial intelligence models.

9. The system of claim 1, wherein determining cumulative optimal global minima error for a system using composite artificial intelligence modeling further comprises:
determining an amount of resources required to implement the composite artificial intelligence model; and
conserving one or more resources associated with the composite artificial intelligence model.

10. A computer program product for determining cumulative optimal global minima error for a system using composite artificial intelligence modeling, the computer program product comprising a non-transitory computer-readable medium comprising code causing an apparatus to:
receive, from a composite artificial intelligence model, wherein the composite artificial intelligence model comprises one or more component artificial intelligence models, one or more component level optimal error points, and wherein the one or more component level optimal error points are associated with the one or more component artificial intelligence models;
aggregate the one or more component level optimal error points;
determine, in response to the aggregated one or more component level optimal error points, an optimal error point, wherein the optimal error point is associated with the composite artificial intelligence model;
receive an acceptance criteria;
compare the optimal error point with the acceptance criteria; and
accept, in response to the optimal error point meeting the acceptance criteria, the optimal error point.

11. The computer program product of claim 10, wherein comparing the optimal error point with the acceptance criteria comprises:
create a decision spectrum;
define the acceptance criteria associated with the decision spectrum;
receive one or more component metrics, wherein the one or more component metrics are associated with the one or more component artificial intelligence models;
determine, in response to the one or more received component metrics, a component score;
compare the component score with the acceptance criteria; and
determine whether the component score meets the acceptance criteria.

12. The computer program product of claim 10, wherein the acceptance criteria comprises a predetermined acceptance score associated with the composite artificial intelligence model.

13. The computer program product of claim 10, wherein the code further causes the apparatus to:
package, in response to the optimal error point being accepted, the optimal error point into the composite artificial intelligence model; and
implement the composite artificial intelligence model into a production environment.

14. The computer program product of claim 9, wherein the code further causes the apparatus to retrain, in response to the optimal error point being outside of the acceptance criteria, the composite artificial intelligence model.

15. The computer program product of claim 14, wherein retraining the composite artificial intelligence model comprises:
reconfiguring one or more hyperparameters associated with the one or more component artificial intelligence models; and
receiving additional training data associated with the one or more component artificial intelligence models.

16. The computer program product of claim 15, wherein reconfiguring the one or more hyperparameters comprises:
receiving historical data associated with the one or more component artificial intelligence models;
comparing the historical data with the optimal error point;
determining, in response to comparing the historical data and the optimal error point, one or more unoptimized component artificial intelligence models; and
reconfiguring the one or more hyperparameters associated with the one or more unoptimized component artificial intelligence models.

17. The computer program product of claim 10, wherein the acceptance criteria is updated to an updated acceptance criteria in response to receiving additional training data associated with the one or more component artificial intelligence models.

18. The computer program product of claim 10, wherein determining cumulative optimal global minima error for a system using composite artificial intelligence modeling further comprises:
determining an amount of resources required to implement the composite artificial intelligence model; and
conserving one or more resources associated with the composite artificial intelligence model.

19. A method for determining cumulative optimal global minima error for a system using composite artificial intelligence modeling, the method comprising:
receiving, from a composite artificial intelligence model, wherein the composite artificial intelligence model comprises one or more component artificial intelligence models, one or more component level optimal error points, and wherein the one or more component level optimal error points are associated with the one or more component artificial intelligence models;
aggregating the one or more component level optimal error points;
determining, in response to the aggregated one or more component level optimal error points, an optimal error point, wherein the optimal error point is associated with the composite artificial intelligence model;
receiving an acceptance criteria;
comparing the optimal error point with the acceptance criteria; and
accepting, in response to the optimal error point meeting the acceptance criteria, the optimal error point.

20. The method of claim 19, wherein comparing the optimal error point with the acceptance criteria comprises:
creating a decision spectrum;
defining the acceptance criteria associated with the decision spectrum;
receiving one or more component metrics, wherein the one or more component metrics are associated with the one or more component artificial intelligence models;
determining, in response to the one or more received component metrics, a component score;
comparing the component score with the acceptance criteria; and
determining whether the component score meets the acceptance criteria.
